(19) United States
(12) Patent Application Publication
(10) Pub. No.: US 2017/0001430 A1
(43) Pub. Date: Jan. 5, 2017

(54) PRINTING STENCIL AND METHOD FOR MANUFACTURING THE SAME

(71) Applicant: TAIYO YUDEN CHEMICAL TECHNOLOGY CO., LTD., Gunma (JP)

(72) Inventor: Kunihiko SHIBUSAWA, Gunma (JP)

(21) Appl. No.: 15/182,835

(22) Filed: Jun. 15, 2016

(30) Foreign Application Priority Data
Jun. 30, 2015 (JP) 2015-131501

(51) Int. Cl. B41F 15/34; C23F 1/00; B41C 1/14

(52) U.S. Cl. CPC B41F 15/34; B41C 1/14; C23F 1/00

(57) ABSTRACT

One object is to provide a printing stencil having a uniformed thickness for excellent printing accuracy and a rough surface for better separation from the printing medium. In accordance with one aspect, a method of manufacturing a printing stencil according to an embodiment of the present invention includes: preparing a substrate having a printing pattern opening formed therein and having a printing surface including an organic material; and performing dry etching on the printing surface.

### CROSS-REFERENCE TO RELATED APPLICATIONS

This application is based on and claims the benefit of priority from Japanese Patent Application Serial No. 2015-131501 (filed on Jun. 30, 2015), the contents of which are hereby incorporated by reference in their entirety.

### TECHNICAL FIELD

The present invention relates to a printing stencil and a method for manufacturing the same, and in particular to a printing stencil used suitably in manufacturing electronic components and a method for manufacturing the same.

### BACKGROUND

Printing stencils are widely used in screen printing for manufacturing electronic components. For example, in manufacturing laminated ceramic capacitors and laminated ceramic inductors, screen printing is used to print an electrically conductive paste including metal fine powder such as Ni or Ag on a green sheet. Printing stencils used in such an application include a frame body, a mesh strung on the frame body, and an emulsion applied to the mesh. A printing pattern opening is formed in the emulsion so as to correspond to a printing pattern. The emulsion may be a photosensitive emulsion for example, and photolithography can be used to form the printing pattern opening in the photosensitive emulsion. The printing stencil may include a printing mask such as a metal mask having a printing pattern opening formed therein and an emulsion applied to the printing mask. The metal mask that can be used for screen printing is disclosed in, e.g., Japanese Patent Application Publication No. Hei 11-245371.

In screen printing, a printing paste is applied to a squeegeed surface of a printing stencil, and a squeegee is pressed against the squeegeed surface and slid thereon with a constant pressure, such that the applied printing paste passes through the printing pattern opening and is transferred to the printing medium.

Methods for applying an emulsion onto a mesh include: a direct method in which an emulsion is applied directly to a mesh with a bucket, etc.; an indirect method in which an emulsion film having a pattern opening formed therein is pasted on a mesh, and a direct-indirect method in which an emulsion film having no pattern opening is pated on a mesh and then a pattern opening is formed in the emulsion film (see Japanese Patent Application Publication No. 2012-215862).

To meet the demand for downsizing of electronic components, electrodes transferred onto a substrate by screen printing should have a smaller thickness. As disclosed in Japanese Patent Application Publication No. 2006-335045, it has been attempted to reduce the thickness of an emulsion on a printing stencil so as to reduce the thickness of electrodes transferred by screen printing.

To uniform the thickness of the electrodes transferred by screen printing, the emulsion formed on the printing stencil should preferably have an uniform thickness. For example, in forming internal electrodes of a laminated ceramic capacitor by screen printing, it is preferable that the thickness of the internal electrodes can be controlled in a submicron unit.

In the direct method and the direct-indirect method, an emulsion film can be formed to have an uniform small thickness, but smaller thickness of the emulsion film makes it more difficult to paste the emulsion film on the mesh. Additionally, in the direct method, it is difficult to maintain constant position of a bucket with respect to a mesh and a constant pressure to press the bucket against the mesh. Therefore, it is difficult to uniform the thickness of the emulsion applied to the mesh, and in particular, it is difficult to control the thickness of the emulsion film in a submicron unit as required for forming the internal electrodes of a laminated ceramic capacitor.

To enhance the printing accuracy of screen printing, it is generally preferable that the emulsion have a uniform thickness and the printing surface of the emulsion have a high smoothness. For example, Japanese Patent Application Publication No. 2010-247534 discloses, in paragraph 0020, a process for forming an emulsion having a uniform thickness by the direct-indirect method or the indirect method and enhancing the smoothness of the surface of the emulsion by mirror-like finishing of the printing surface of the emulsion formed by the direct method.

However, enhancing the uniformity in thickness of an emulsion and the smoothness of the printing surface thereof produces the following drawbacks. First, if a coating film for protection is provided on the surface of the emulsion, high smoothness of the surface of the emulsion reduces the fixation of the coating film. Additionally, since the light beams applied for exposure tend to be scattered at the smooth surface of the emulsion, the scattered light may enter and strike the printing pattern opening in the emulsion. Thus, part of the inner walls of the printing pattern opening is removed by the exposure, and as a result, the inner walls are roughened. This causes more difficulty in passing the printing paste through the printing pattern opening. Further, if the smoothness of the printing surface of the emulsion is very high, the scattered light is dispersed and does not strike the surface of the emulsion again, which reduces the efficiency of exposure.

In the off-contact printing, a printing stencil and a printing sheet are faced with each other with an adequate gap therebetween for preventing contact, and the printing stencil is pressed against the printing medium by a squeegee such that the surface layer of the printing stencil is contacted with the printing medium for transfer of an ink. If the off-contact printing is used the ink is less prone to bleed and the accuracy of printing is higher as the time during which the surface layer of the printing stencil is contacted with the printing medium (“the stencil separation time” required for the screen contacted with the printing medium to be separated therefrom when the squeegee passes) is shorter. However, if the surface of the printing stencil is so smooth that the air between the printing stencil and the printing medium cannot flow out, the printing stencil may be adhered to the printing medium, and it may be difficult to fix the printing paste at a predetermined position on the printing medium (see, e.g., Japanese Patent Application Publication No. Hei 8-118834).

### SUMMARY

The present disclosure addresses at least a part of the above-described disadvantages. For example, one object of the present disclosure is to uniform the thickness of a printing stencil so as to obtain an excellent printing accuracy, and to roughen the surface of the printing stencil such that it can be separated well from the printing medium. Another object of the present disclosure is to reduce the thickness of the printing stencil. Still another object of the present disclosure is to enable fine control of the thickness of the printing stencil (e.g., in a submicron unit).

A method of manufacturing a printing stencil according to an embodiment of the present invention comprises: preparing a substrate having a printing pattern opening formed therein and having a printing surface including an organic material; and performing dry etching on the printing surface.

The printing stencil according to an embodiment of the present invention comprises a substrate having a printing pattern opening formed therein and having a printing surface including an organic material. In an embodiment of the present invention, the printing surface has one or more projections formed therein by dry etching.

According to these embodiments, the thickness of the substrate can be reduced by performing dry etching on the printing surface. The thickness of the substrate can be reduced in a submicron unit by adjusting the process condition of the dry etching (e.g., process time, or the concentration of the material gas). Further, since a larger amount can be removed from thick portions by dry etching, the thickness of the substrate can be uniformed in a macro region, thereby to improve the printing accuracy. Additionally, the printing surface of the substrate composed of an organic material may be subjected to dry etching to form nano-order projections (an unevenness structure) in the printing surface, which allow passage of air and prevent the printing stencil from attaching on the printing medium.

A printing stencil in an embodiment of the present invention is a screen printing plate having a mesh strung on a frame. This mesh is provided with an emulsion, and a printing pattern opening is formed in the emulsion. The emulsion may be formed on the mesh by any of the direct method, the indirect method, and the direct-indirect method A printing stencil in another embodiment of the present invention is a printing mask such as a metal mask, an electrotyping mask, or a resin mask.

In an embodiment of the present invention, the dry etching is performed using a material gas including at least one element selected from the group consisting of O, N, H, F, and Ar.

In an embodiment of the present invention, the substrate includes an additive, and the dry etching is performed so as to form one or more projections including the additive in the printing surface. The additive is at least one substance selected from the group consisting of metal elements, metal oxides, and glass. The metal elements that can be used as the additive include Si, Ti, Al, Zr, and other metal elements that are less prone to be etched by plasma. For example, if O, N, H, F, Ar, or a mixture gas thereof is used as a material gas, a metal element that is less prone to be etched by the plasma of this material gas (or radicals or ions of this material gas) may be selected as the additive. The metal oxides and glass that can be used as the additive of the present invention include any metal oxides and/or glass that are less prone to be etched by the plasma gas.

In these embodiments, the additive contained in the emulsion serves as a mask for etching and remains along with the portion of the emulsion therebelow as the etching residue. As a result, the surface of the emulsion after the etching has projections made of the etching residue. Thus, since the portions of the surface (the printing surface) of the emulsion not containing the additive are removed, the average thickness of the emulsion can be reduced as compared to that before the etching.

In an embodiment of the present invention, the emulsion is a photosensitive emulsion and the emulsion is exposed to light after the etching. Next, development is performed on the emulsion after the exposure to form a printing pattern opening in the emulsion. In the embodiment, the light beam for exposure scattered at the side surfaces of the projections formed in the printing surface by etching tends to strike again the printing surface of the emulsion, thereby increasing the efficiency of exposure. Further, since the light beam for exposure scattered at the printing surface of the emulsion can be prevented from striking the printing pattern opening, the inner walls of printing pattern opening can be restricted from roughening and degrading the releasing performance of the printing paste.

In the above embodiment, the printing surface of the emulsion is activated by dry etching and has projections formed therein, the printing surface has high hydrophilicity and oleophilicity.

In an embodiment of the present invention, a coating film is formed on the printing surface of the emulsion after the etching. As described above, the printing surface has projections formed therein; and therefore, the coating film can be fixed well on the printing surface due to the anchor effect.

In an embodiment of the present invention, the printing surface is etched such that the average roughness (Rz) of the printing surface is smaller than the average particle diameter of the metal fine powder included in the printing paste. In the embodiment, the printing paste filled in the printing pattern opening of the emulsion is less prone to spread from the printing pattern opening to other portions of the emulsion. Thus, the printing paste can be transferred to the printing medium in accordance with the printing pattern with a high printing accuracy.

In the embodiments of the present disclosure, the thickness of a printing stencil is unformed so as to obtain an excellent printing accuracy, and the surface of the printing stencil is roughened such that it can be separated well from the printing medium. The other advantages of the present disclosure will be apparent with reference to other description in this specification.

### BRIEF DESCRIPTION OF THE DRAWINGS

FIG. 1 is a schematic plan view illustrating the general configuration of a printing stencil (screen printing plate) according to an embodiment of the present invention.

FIG. 2 is a schematic sectional view illustrating the printing stencil (screen printing plate) according to the embodiment of the present invention.

FIG. 3 is a schematic sectional view illustrating the printing stencil (printing mask) according to the embodiment of the present invention.

FIG. 4 is a schematic enlarged sectional view illustrating the portion around a printing surface of the screen printing plate according to an embodiment of the present invention.

FIG. 5 is a schematic enlarged sectional view illustrating the portion around a printing surface of the screen printing plate according to an embodiment of the present invention.

FIG. 6 is a laser microscope photograph of the portion of an emulsion screen printing plate not subjected to dry etching (the portion subjected to masking).

FIG. 7 is a laser microscope photograph of the portion of an emulsion screen printing plate subjected to dry etching (the portion not subjected to masking).

FIG. 8 is an electron microscope photograph of the surface of an emulsion formed in accordance with an embodiment of the present invention.

FIG. 9 is an electron microscope photograph of the surface of an emulsion formed in accordance with an embodiment of the present invention.

FIG. 10 is an electron microscope photograph of the surface of an emulsion formed in accordance with an embodiment of the present invention.

FIG. 11 is an electron microscope photograph of a comparative example.

### DESCRIPTION OF EXAMPLE EMBODIMENTS

Various embodiments of the present disclosure will now be described with reference to the attached drawings. In the drawings, the same or similar components are denoted by the same or similar reference signs, and the detailed description of the same or similar components is omitted if not necessary.

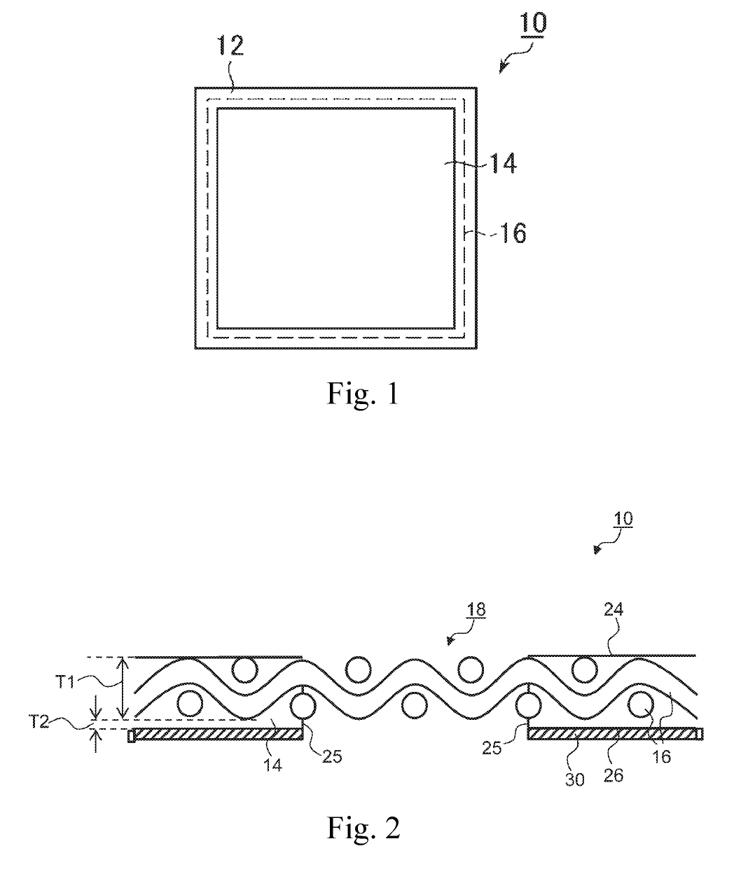

FIGS. 1 and 2 show a screen printing plate 10 as an example of a printing stencil according to an embodiment of the present invention. The screen printing plate 10 may include a frame 12 composed of an iron casting, a stainless steel, or an aluminum alloy, a mesh 16 strung on the frame 12, and an emulsion 14 applied to the entirety of a part of the mesh 16. As will be described later, a printing pattern opening 18 may be formed in the emulsion 14.

The mesh 16 according to an embodiment of the present disclosure may be fabricated by weaving threads of various metal materials. The mesh 16 may also be formed of materials other than metals such as resins, glass fibers, carbon fibers, or a composite material of the foregoings. If the mesh 16 is composed of a material containing carbon, the diameter of the threads of the mesh 16 may be reduced in the etching process (described later); and therefore, the mesh 16 may be formed of threads having a diameter larger by the amount to be lost in the etching process.

The surface roughness, sectional shape, and weaving method of the threads constituting the mesh 16 may be appropriately varied in accordance with the applications. The sectional shapes may include, for example, circular, oval, rectangular, polygonal, irregular, and star shapes. Examples of weaving method may include plain weave, twill weave, and three-dimensional weave. The material of the threads constituting the mesh 16 may be, for example, a metal such as stainless steel, steel, copper, titanium, or tungsten or an alloy thereof. The metal may also be an amorphous metal, etc. For example, the mesh 16 may be a mesh #500-19. In a mesh #500-19, the wire rods (fiber threads) constituting the mesh may have a diameter of 19 μm, the mesh openings (i.e., the intervals between the neighboring wire rods) may have a width of about 30 μm, and the mesh count may be 500. The mesh count of 500 may indicate that 500 mesh wire rods are present in a width of one inch.

The mesh 16 may be fixed at the portions where fiber threads cross each other (intersections) with a plating extract, adhesive, vapor-deposited film, or sputtered film. The plating extract may be formed by, for example, electrolytic Ni plating, electrolytic Ni—Co alloy plating, or electrolytic Cr plating. In an embodiment, the intersections between the threads of the mesh may be compressed to reduce the thickness of the mesh 16 to the thickness of one thread of the mesh. The specifications of the mesh 16 are not limited to those described herein such as the substance, wire diameter, mesh count, uniformity of the size of mesh openings, positions of mesh openings, taper angle of mesh openings, and shape of the openings; these specifications may be varied as necessary in accordance with the printing method, printing pattern, printing medium, and required endurance. In an embodiment, the mesh 16 may be ordinarily fabricated by weaving thread-like material but may also be fabricated by other methods. For example, the mesh 16 may be fabricated by electrotyping, printing, and photolithography. Also, the mesh 16 may be fabricated by forming through-holes in a substrate by various methods such as laser processing, etching, drilling, punching, and electric discharging. The through-holes formed in these processes may correspond to the openings of the mesh 16. The above materials and fabrication methods may be appropriately combined. Further, the edges of the openings of the mesh 16 may be appropriately chamfered. The mesh 16 may be a combination of a plurality of meshes. For example, meshes of the same type or different types may be combined together.

A printing stencil according to another embodiment of the present invention may be a mask having a printing pattern opening formed therein. The mask may be a metal mask (also referred to as a stencil), an electrotyping mask, or a resin mask. A metal mask may be fabricated by forming a printing pattern opening in a metal film such as a stainless steel film by various methods such as laser processing, etching, electrotyping, pressing, or drilling. An electrotyping mask may be fabricated by electrotyping using Ni plating, Ni alloy plating with Ni—Co, Ni—W, etc., Cu plating, Cu alloy plating, and plating with other metals. Further, a resin mask may be, e.g., a resin film having a printing pattern opening formed therein by an ordinary method. These mask plates having a printing pattern opening formed therein may be fixed on a mesh and used as a substrate of the printing stencil of the present invention. Such a printing stencil may be provided with an emulsion, a resin or rubber film containing carbon, and/or a film for the purpose of increasing the unevenness conformity of the printing sheet substrate, protecting the printing sheet substrate against damage, increasing the tight adhesion to the printing substrate, and/or other purposes. The printing stencil of the present invention may have a planar, cylindrical, or any other shape in accordance with the application thereof. In relief printing plates and intaglios such as gravure printing plates, a resin layer may be formed as a cushion layer in the surface layer of the printing pattern. Likewise, the emulsion, the resin or rubber film containing carbon, and/or the film described above may be formed in the surface layer of the printing stencil of the present invention.

In an embodiment of the present invention, the emulsion 14 may be a photosensitive resin emulsion containing carbon. A photosensitive resin emulsion can be categorized into a photocrosslinking type, a photo polymerization type, or a hybrid type, depending on the photo-setting form thereof. The emulsion 14 may be of any of these types. Carbon-containing emulsions that can be used as the emulsion 14 may include, e.g., a mixture of polyvinyl alcohol, vinyl acetate polymer (or acryl monomer), and photocrosslinking diazo resin, and a mixture of polyvinyl alcohol, acryl monomer, and photopolymerization initiator. The photosensitive emulsion 14 may be of the positive type or the negative type.

The emulsion 14 according to an embodiment of the present invention may include an additive made of a metal element, a metal oxide, or glass. The metal elements that can be used as the additive may include Si, Ti, Al, and Zr. Any other substances that are less prone to be etched by plasma gas can be used as the additive in the present invention. The additive may be almost uniformly dispersed at least in the portion near the printing surface 16 of the emulsion 14.

A printing pattern opening 18 may be formed in the emulsion 14 by, for example, photolithography so as to correspond to a printing pattern. The printing pattern opening 18 may be formed so as to penetrate the emulsion 14 in the thickness direction. In a photolithographic process, the emulsion 14 applied to the mesh 16 may be exposed to light in a photomask pattern to cure part of the emulsion 14, and then the other region of the emulsion 14 than the part cured by the exposure to light may be removed to leave only the cured part on the mesh 16, so that the printing pattern opening 18 is formed. The printing pattern opening 18 may be defined by inner walls 25 of the emulsion 14. The emulsion 14 may be formed on the mesh 16 by any of the direct method, the indirect method, and the direct-indirect method. If the emulsion 14 is provided on the mesh by the direct method or the direct-indirect method, the exposure may be performed after the emulsion 14 is provided on the mesh 16. On the other hand, if the emulsion 14 is provided on the mesh 16 by the indirect method, a printing pattern may be formed on an emulsion film by exposure and development, and the emulsion film having the printing pattern formed thereon may be pasted on the mesh 16.

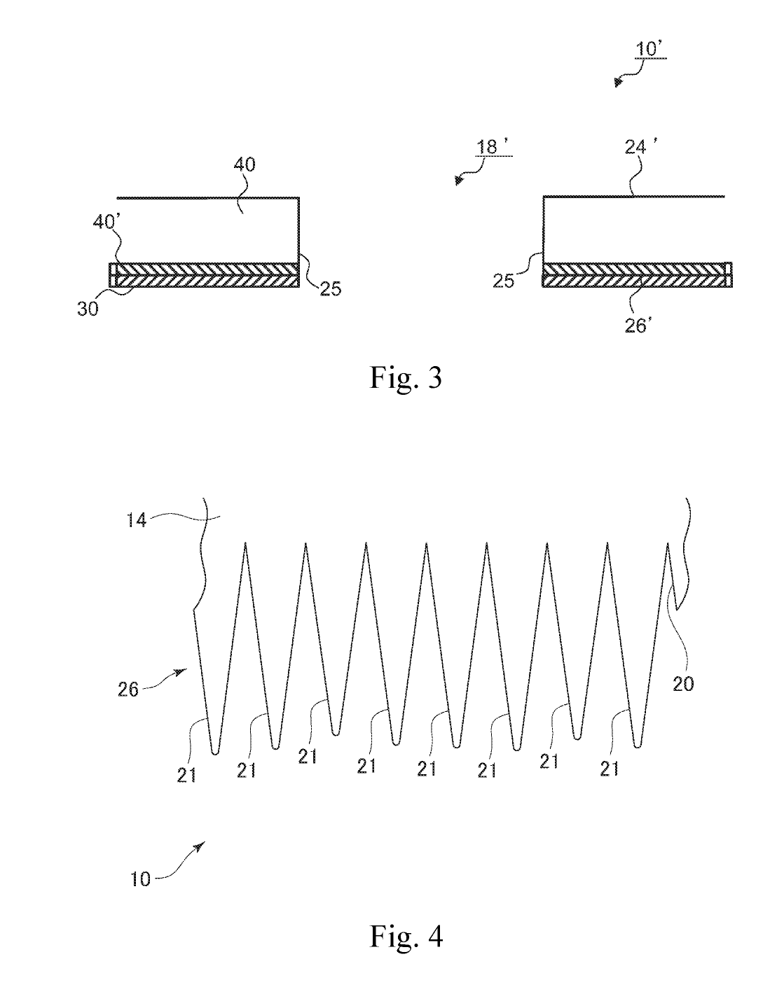

FIG. 3 shows a printing mask 10′ as an example of a printing stencil according to an embodiment of the present invention. The mask 10′ may be a metal mask (also referred to as a stencil), an electrotyping mask, or a resin mask. As shown, the mask 10′ may include a mask substrate 40 having a printing pattern opening 18′ formed therein. The mask substrate 40 may be made of a metal film such as a stainless steel film. The printing pattern opening 18′ may be formed in the mask substrate 40 by laser processing, etching, electrotyping, pressing, or drilling.

At least the printing surface 26′ of the mask substrate 40 may be formed of an organic material containing carbon. For example, the mask substrate 40 may be a resin mask made of a resin containing carbon. If the mask substrate 40 is made of a material not containing carbon such as stainless steel, a film 40′ containing carbon may be formed on the printing surface 26′ side of the mask substrate 40. In this case, the film 40′ may be regarded as a part of the mask substrate 40, and the surface of the film 40′ may constitute the printing surface 26′ of the mask substrate 40. The film 40′ may be made of a carbon-containing emulsion for over-coating, a coupling agent containing carbon serving as an adhesive layer to the upper layer, a surfactant containing carbon, or a hard film containing carbon (e.g., an amorphous carbon film).

In an embodiment of the present invention, the printing surface 26 of the emulsion 14 (or the printing surface 26′ of the mask substrate 40) may be subjected to dry etching by generating a plasma of a material gas including at least one of O, N, H, F, Ar, and other elements and applying the generated plasma to the printing surface 26 of the emulsion 14 (or the printing surface 26′ of the mask substrate 40). In another embodiment of the present invention, the printing surface 26 (or the printing surface 26′ of the mask substrate 40) may be subjected to dry etching by generating radicals and ions of the material gas by plasma discharge and reacting the printing surface 26 of the emulsion 14 (or the printing surface 26′ of the mask substrate 40) with at least one of the generated radicals and ions. The description of the etching process on the printing surface of the printing stencil may be herein simplified and focused on the etching process on the printing surface 26 of the emulsion 14 of the screen printing plate 10 while omitting the process on the printing surface 26′ of the mask substrate 40. It should be noted that the etching process on the printing surface 26 of the emulsion 14 of the screen printing plate 10 may also be performed on the printing surface 26′ of the mask substrate 40 in the same manner. The additive made of the metal element, metal oxide, or glass and added into the emulsion 14 may be added to a portion near the printing surface 26′ of the mask substrate 40.

Such dry etching may be performed using apparatuses for vacuum plasma processes such as a plasma CVD apparatus or a plasma PVD apparatus. The dry etching of the printing surface 26 may be performed using at least one of the plasma, radicals, and ions generated by the atmospheric-pressure plasma process, UV irradiation, corona discharge process, or other various known methods. The etching of the printing surface 26 may be performed either before or after the printing pattern opening is formed in the emulsion 14 or may be performed both before and after the printing pattern opening is formed.

If a plasma gas containing O is used to etch the emulsion 14 containing carbon, the plasma may react with carbon (C) in the emulsion 14 to generate COₓ gas so as to etch the emulsion 14. Likewise, if a plasma gas containing N is used to etch the emulsion 14 containing carbon, the plasma may react with carbon (C) in the emulsion 14 to generate CNₓ gas, and if the plasma contains H, the plasma may react with carbon (C) in the emulsion 14 to generate CHₓ gas.

If the emulsion 14 applied onto the mesh 16 is uneven and has projections and recesses, the etching can be concentrated on the projections of the emulsion 14 which are more capable of passing plasma electric current than the recesses. As a result, the thickness of the emulsion 14 can be uniformed in a macro region. Accordingly, the plasma may be applied to the printing surface 26 of the emulsion 14 so as to reduce and uniform the thickness of the emulsion 14 in a macro region. The macro region may be larger than, e.g., an aperture of the mesh 16 included in the screen printing plate (i.e., an opening of the mesh 16 enclosed rectangularly by fiber threads of the mesh). For example, the intervals between fiber threads in a mesh #500 are about 30 μm.

The plasma, radicals, and ions generated from a material gas containing at least one element selected from the group consisting of O, N, H, F, and Ar do not react with the mesh 16 made of a metal material. If the mesh 16 is made of a metal material, the above-described material gas may be used to etch the emulsion 14 without etching the mesh 16. Thus, the emulsion 14 may be selectively etched to reduce the thickness of the emulsion 14 without reducing the volume of the mesh 16.

If the mesh 16 is made of a resin or an organic material other than resins containing carbon, the etching with plasma may reduce the thickness of the portion of the mesh 16 exposed to the printing pattern opening 18; but the etching may be performed before the printing pattern opening 18 is formed, so as to prevent the mesh 16 from being etched. In an embodiment in which the mesh 16 is made of an organic material, even if the etching is performed after the printing pattern opening 18 is formed, the wire diameter of the mesh 16 may be larger than the predetermined wire diameter required for the finished work such that the portion of the mesh 16 exposed to the printing pattern opening 18 has the predetermined wire diameter after the etching.

The Inventor of the present invention has found that at least one of the plasma, radicals, and ions generated from the material gas containing O, N, H, F, Ar, etc. can be applied to the surface of a substrate containing carbon (e.g., the emulsion 14 containing carbon) to form on the surface of the substrate a fine unevenness structure that do not rely on the unevenness structure of the substrate. In an embodiment of the present invention, as described above, at least one of the plasma, radicals, and ions generated from the material gas containing O, N, H, F, Ar, etc. can be applied to the printing surface 26 of the emulsion 14 to form a fine unevenness structure on the printing surface 26 that roughens the printing surface 26. The average roughness (Rz) of the printing surface 26 having the fine unevenness structure formed thereon can be adjusted within a region from several tens to several hundreds of nanometers by varying the parameters such as the process time of the printing surface 26 with the plasma, radicals, and/or ions, the concentration of the material gas, and the power source voltage of the plasma generation apparatus.

The fine structure formed in the surface of the emulsion 14 will now be described with reference to FIG. 4. FIG. 4 is a schematic enlarged sectional view illustrating the portion around the printing surface 26 of the emulsion 14 of the screen printing plate 10 shown in FIG. 2. As shown in FIG. 3, the printing surface 26 of the emulsion 14 may have a large number of recesses 20 formed by removing a part of the emulsion 14 by the etching process described above and a large number of projections 21 remaining after the etching as the etching residue.

As described above, the emulsion 14 according to an embodiment may include an additive such as Si, Ti, Al, Zr, etc. When the emulsion 14 including the additive is subjected to the plasma etching described above, the additive may serve as a mask and remain along with the portion of the emulsion therebelow as the etching residue. As a result, the printing surface 16 of the emulsion 14 after the etching may have a large number of projections made of the etching residue. The etching residue (projections) may be formed like needles (or cones) as in black silicon, and the portions near the peaks thereof may include the additive or a compound formed by reaction of the additive with the plasma. For example, if the emulsion 14 containing Si is etched using plasma containing oxygen, the reaction between Si in the emulsion 14 and the oxygen may produce SiOₓ in the emulsion 14, and the produced SiOₓ and the portion of the emulsion 14 below SiOₓ may remain as the etching residue. As a result, the printing surface 26 of the emulsion 14 after the etching may have a large number of projections (etching residue) including SiOₓ near the peaks thereof.

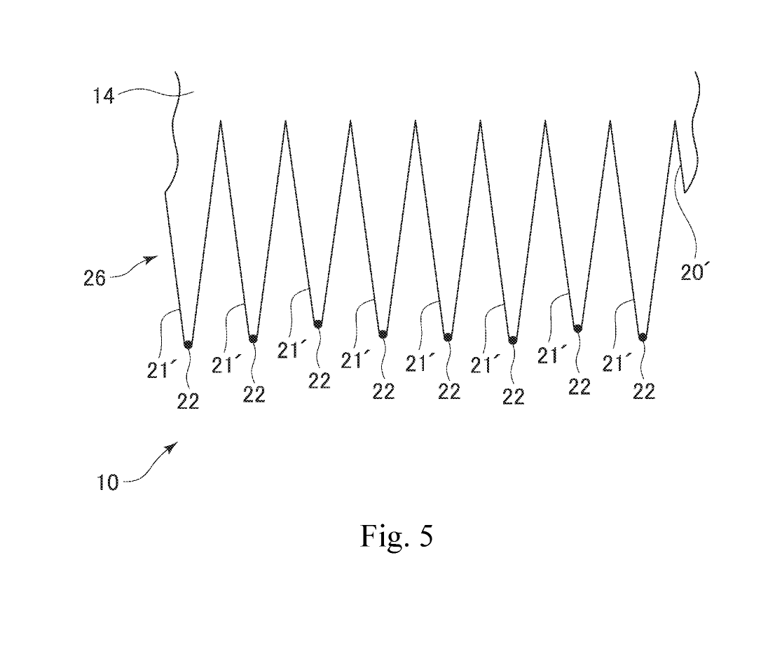

The fine structure formed in the surface of the emulsion 14 will now be described with reference to FIG. 5. FIG. 5 is a schematic enlarged sectional view illustrating the portion around the printing surface 26 of the emulsion 14 of the screen printing plate 10 shown in FIG. 2. As shown in FIG. 5, the printing surface 26 of the emulsion 14 may have a large number of recesses 20 formed by removing a part of the emulsion 14 by plasma etching and a large number of projections 21 remaining after the etching as the etching residue. As described above, the emulsion 14 may be etched by applying at least one of the plasma, radicals, and ions generated from the material gas containing O, N, H, F, Ar, etc. Such plasma, radicals, and ions may have a high etching capability on the emulsion 14 but have a low and almost no etching capability on the additive 22 (Si, Ti, Al, and Zr, and a compound thereof). Accordingly, when the emulsion 14 including much additive 22 is etched by the plasma, the portions of the emulsion 14 not including the additive 22 is etched deeply to form recesses 20′, while the portions including the additive 22 is not etched and the additive 22 and the portion of the emulsion 14 therebelow may remain as projections 21′. The projections 21′ may be protected by the additive 22 against the plasma, radicals, and ions, and thus tend to have a more sharp shape than the projections 21 shown in FIG. 4. As a result, if the emulsion 14 includes the additive 22 near the printing surface 26 thereof (FIG. 5), the printing surface 26 may be more likely to be roughened than in the case where the emulsion does not include the additive 22 (FIG. 4).

Since the printing surface 26 (printing surface 26′) of the printing stencil of the present invention have a large number of projections 21 (projections 21′), the spaces between the projections 21 (projections 21′) can release and contain the air, which may restrict the printing surface 26 from being adhered to the printing medium.

The height of the projections 21 (projections 21′) formed in the printing surface 26 (printing surface 26′) can be adjusted within a range from several tens to several hundreds of nanometers. The unevenness structure having a nano order size formed in the printing surface 26 (printing surface 26′) may be negligible small irregularity in the macro region (e.g., a region of 30 μm square).

In an embodiment of the present invention, the printing surface 26 (printing surface 26′) may be etched such that ten point average roughness (Rz) of the printing surface 26 (printing surface 26′) measured in accordance with JIS B0601 (1994) is smaller than the average particle diameter of the metal fine powder included in the printing paste used. The average particle diameter of the metal fine powder refers to the average particle diameter of the powder measured by dry laser diffractometry. This average particle diameter can be measured by the laser diffractometric particle size distribution measurement apparatus (LA-950 from HORIBA, Ltd.). In the embodiment, the printing paste filled in the printing pattern opening 18 of the emulsion may be less prone to spread from the printing pattern opening 18 to the portions of the printing surface 26 (printing surface 26′) other than the printing pattern opening 18. Thus, the printing paste can be transferred to the printing medium in accordance with the printing pattern with a high printing accuracy. For example, fine Ni powder included in an electrically conductive paste used for forming electrodes of a laminated ceramic capacitor has a particle diameter of about 200 nm. If the printing paste includes fine Ni powder having an average particle diameter of 200 nm, the emulsion may be etched such that the average roughness of the printing surface is less than 200 nm.

The etching of the emulsion 14 described above is chemical etching using chemical reactions by a dry process, in which no stress is applied to the mesh 16 or the emulsion 14. This is advantageous because it does not suffer from undesired deformation of the mesh 16 or the emulsion 14, occurrence of residual stress, slackness in the tension of the mesh 16, deterioration (chipping or sagging) in the shape of the edge of the printing pattern opening 18 of the emulsion 14. This advantage is significant as compared to other methods of roughening the surface of the emulsion 14, such as sandblasting or polishing with a file.

In the etching of the emulsion 14, the amount of etching can be adjusted finely by adjusting the time of plasma discharge, enabling fine adjustment of the degree of reducing the thickness of the emulsion 14. As described above, if the thickness of the emulsion 14 is uneven, a larger amount can be removed from thick portions to uniform the thickness. These advantages are also specific to the above embodiment of the present invention and are difficult to achieve in sandblasting and surface polishing.

Further, even if the emulsion remains on the portion of the mesh 16 exposed to the printing pattern opening 18 in the process of forming the printing pattern opening 18, the unwanted emulsion remaining in the printing pattern opening 18 can be removed by the etching described above.

As shown in FIG. 5, the additive 22 may be contained near the surface of the emulsion 14, and thus the additive 22 may be concentrated at the surface of the emulsion after dry etching of the emulsion 14. If oxygen is used as the material gas for plasma, it may be presumed that the additive 22 be oxidized. The oxidized additive can be deoxidized using hydrogen plasma, for example. Thus, if the additive 22 is an electrically conductive metal, an electrically conductive layer can be formed in the surface layer of the insulating emulsion film. Thus, an electrically conductive layer may be formed on the surface of the emulsion 14 so as to remove static electricity generated by the screen printing plate 10 contacting the printing medium, thereby preventing damage of the printing medium and adhesion between the screen printing plate 10 and the printing medium caused by the static electricity generated by the friction between the screen printing plate 10 and the printing medium during printing.

The printing surface 26 of the emulsion 14 may be provided with a coating film 30. The coating film 30 may be, e.g., an emulsion film for overcoating or a film made of a coupling agent. The surface of the emulsion 14 energized by etching may be coated with the coating film 30. The coating film 30 may also serve as an adhesive layer to the upper layer. Further, the coating film 30 may be a surfactant film for improving the surface wettability and forming a static electricity preventing layer. Additionally, the coating film 30 may be a hard film such as an amorphous carbon film, a resin film such as an epoxy film, a resin film such as a polyimide or polyimide-amide film, or an adhesive resin film.

As described above, the printing surface 26 of the emulsion 14 may have the projections 21 (and/or the projections 21′) formed therein; and therefore, the coating film 30 can be fixed well on the printing surface 26 due to the anchor effect. The emulsion 14 may include an additive such as Si, Ti, Al, Zr, etc. or a compound of the additive (e.g., SiO₂, Al₂O₃) produced by the reactive etching. Therefore, the coating film 30 may be made of fluorine-containing coupling agent or a fluorine coating agent, such that hydroxyl groups originating from the above additive or the compound thereof included in the surface layer of the emulsion 14 can be tightly bound to the coating film 30 by dehydration condensation reaction. In an embodiment, the coating film 30 may have a thickness ranging from several to several tens of nanometers so as not to fill the unevenness structure of the projections 21 formed in the printing surface 26 of the emulsion 14.

The coating film 30 may be formed of, e.g., a fluorine-containing coupling agent. One example of the fluorine-containing coupling agent may be Fluorosurf FG-5010Z130-0.2 (containing 0.02 to 0.2% fluorine resin and 99.8 to 99.98% fluorine-based solvent) from Fluoro Technology Corporation. The coating film 30 may be formed of a fluorine-containing coupling agent on the printing surface of the emulsion 14, so as to provide water repellence and/or oil repellence to the printing surface of the emulsion. The silane coupling agent chemically binds to the hydroxyl groups originating from the additive such as Si, Ti, Al, Zr, etc. and a compound thereof in the emulsion 14 (e.g., by a bond due to a dehydration condensation reaction or a hydrogen bond). Therefore, a continuous planar fluorine resin film including a tight binding bridge layer may be formed on the printing surface 26 of the emulsion 14. The coating film 30 may be provided so as not to block the printing pattern opening 18.

The fluorine-containing coupling agent may include a substituent of fluorine in the molecular structure thereof and provide water repellence and oil repellence qualities. The fluorine-containing coupling agents that can be used for the coating film 30 may include the following.
(i) CF3 (CF2)7 CH2 CH2 Si(OCH3)3
(ii) CF3 (CF2)7 CH2 CH2 SiCH3 Cl2
(iii) CF3 (CF2)7 CH2 CH2 SiCH3 (OHC3)2
(iv) (CH3)3 SiOSO2 CF3
(v) CF3 CON(CH3) SiCH3
(vi) CF3 CH2 CH2 Si(OCH3)3
(vii) CF3 CH2 SiCl3
(viii) CF3 (CF2)5 CH2 CH2 SiCl3
(ix) CF3 (CF2)5 CH2 CH2 Si(OCH3)3
(x) CF3 (CF2)7 CH2 CH2 SiCl3

These fluorine-containing coupling agents are mere examples, and the fluorine-containing coupling agents applicable to the present invention are not limited to these examples.

The coating film 30 may have two-layer structure including a first layer composed mainly of a coupling agent and a second layer composed mainly of a water repellent material or a water- and oil-repellent material. The first layer may be a thin film composed of, for example, a coupling agent that can form, on the emulsion, hydrogen bonding and/or an —O-M bonding (M is any one element selected from the group consisting of Si, Ti, Al and Zr) by condensation reaction, with the emulsion layer. Such coupling agents may include, for example, silane coupling agent, titanate-based coupling agent, aluminate-based coupling agent, and zirconate-based coupling agent. These coupling agents may be used combinedly with other coupling agents. The second layer may be a thin film composed of a water repellent material, for example, alkylchlorosilanes such as methyltrichlorosilane, octyltrichlorosilane, and dimethyldichlorosilane, alkylmethoxysilanes such as dimethyldimethoxysilane and octyltrimethoxysilane, hexamethyldisilazane, a silylation agent, and silicone. Also, the thin film composed of the above fluorine-containing silane coupling agent may be used as the second layer. The water repellent materials, oil repellent materials, or water- and oil-repellent materials that can be used as the second layer are not limited to those explicitly described herein.

Silane coupling agents are widely used and no example is required to be cited for this. In the embodiment of the present invention, various silane coupling agents commercially available can be used. One example of the silane coupling agent applicable to the present disclosure is decyltrimethoxysilane (trade name “KBM-3103” from Shin-Etsu Chemical Co., Ltd.).

The titanate-based coupling agents constituting the water- and oil-repellent layer and applicable to the present invention may include tetramethoxytitanate, tetraethoxytitanate, tetrapropoxytitanate, tetraisopropoxytitanate, tetrabutoxytitanate, isopropyltriisostearoyltitanate, isopropyltridecylbenzenesulfonyltitanate, isopropyl tris(dioctyl pyrophosphate)titanate, tetraisopropyl bis(dioctylphosphite)titanate, tetra(2,2-diaryloxymethyl-1-butyl) bis(ditridecyl)phosphite titanate, bis(dioctylpyrophosphate)oxyacetate titanate, bis(dioctylpyrophosphate)ethylene titanate, isopropyltrioctanoyltitanate, and isopropyltricumylphenyltitanate. The product named “Plenact 38S” (from Ajinomoto Fine-Techno Co., Inc.) is commercially available.

The aminate-based coupling agents constituting the water- and oil-repellent layer and applicable to the present invention may include aluminum alkyl acetoacetate diisopropylate, aluminum ethyl acetoacetate diisopropylate, aluminum trisethyl acetoacetate, aluminum isopropylate, aluminum diisopropylate monosecondary butylate, aluminum secondary butylate, aluminum ethylate, aluminum bisethyl acetoacetate monoacetyl acetonate, aluminum trisacetyl acetonate, and aluminum monoisopropoxy monooleoxy ethyl acetoacetate. The product named “Plenact AL-M” (alkyl acetate aluminum diisopropylate from Ajinomoto Fine-Techno Co., Inc.) is commercially available.

The zirconia-based coupling agents constituting the water- and oil-repellent layer and applicable to the present invention may include neopentyl(diaryl)oxy, trimethacryl zirconate, tetra(2,2 diaryloxy methyl)butyl, di(ditridecyl)phosphate zirconate, and cyclo[dineopentyl(diaryl)]pyrophosphate dineopentyl(diaryl)zirconate. The product named “Ken-React NZ01” (from Kenrich Petrochemicals, Inc.) is commercially available.

An example of a method for manufacturing the screen printing plate 10 will now be described. First, the frame 12 and the mesh 16 may be prepared, and the mesh 16 may be attached to the frame 12. The mesh 16 may be either directly attached to the frame 12 or indirectly attached via a support screen. Next, the emulsion 14 may be applied onto the mesh 16, and the surface (in particular, the printing surface 26) of the emulsion 14 may be etched using plasma including at least one element selected from the group consisting of O, N, H, F, and Ar. Next, the emulsion 14 applied onto the mesh 16 may be exposed to light in accordance with the mask pattern of a photomask by photolithograpy, etc., thereby curing a part of the emulsion. Next, development is performed on the emulsion after the exposure to remove a portion of the emulsion 14 not exposed to light, thereby forming the printing pattern opening 18. Through these processes, the screen printing plate 10 can be obtained. Additionally, the etching may be performed after the printing pattern opening 18 is formed.

In forming the printing pattern opening 18 by photolithography, etc., a light beam may be applied to the printing surface 26 of the emulsion 14 during exposure. As shown in FIGS. 4 and 5, the printing surface 26 (printing surface 26′) may have a large number of projections 21 (projections 21′), and therefore, the light beam scattered at the printing surface 26 (printing surface 26′) may tend to strike again other portions of the printing surface 26 (printing surface 26′), instead of being lost. For example, much of the light beam striking the inclined surface of a projection 21 (projection 21′) and scattered may strike the inclined surface of an adjacent projection 21 (projection 21′). Thus, the printing surface 26 (printing surface 26′) of the printing stencil may have a large number of projections 21 (projections 21′), and therefore, the light beam for exposure scattered at the printing surface 26 (printing surface 26′) of the printing stencil may tend to strike again other portions of the printing surface 26 (printing surface 26′), thereby increasing the efficiency of exposure. This may also restrict unwanted irregularity in the inner wall 25 produced by the scattered light striking the inner wall 25 of the printing pattern opening 18 and causing unnecessary exposure of the inner wall 25. Hence, the deterioration of the quality of transferring the printing paste can be restricted.

The screen printing plate 10 and the printing mask 10′ may be arranged such that the printing surface 26 (printing surface 26′) thereof faces the printing medium during use. After the screen printing plate 10 is disposed at a predetermined position, printing paste, such as solder paste or metallic paste for forming an inner electrode of an electronic component, may be applied onto the squeegeed surface 24 (squeegeed surface 24′), and then a squeegee (not illustrated) may be slid along the squeegeed surface 24 while the squeegeed surface 24 is pressed by the squeegee at a certain level of pressure, so that the applied printing paste passes through the printing pattern opening 18 and is then transferred to the printing medium. In addition to these printing pastes, the screen printing plate 10 and the printing mask 10′ may be used to transfer printing ink, dye, paint, antirust, adhesive, reactive material, slurry for green sheets, resist for lithography, pressure-sensitive material, temperature-sensitive material, and adsorbent.

### EXAMPLES

It was confirmed that an emulsion film having a thin uniform thickness can be obtained by dry etching of a carbon-containing emulsion in the following method.

First, a frame having a size of 320 mm by 320 mm and a screen mesh #640-15 made of SUS304 and having a size of 200 mm by 200 mm (calendered by pressing and thinning the intersections of the mesh fiber threads) were prepared. This screen mesh had a thickness of 18 μm (corresponding to T1 in FIG. 2). The screen mesh was mounted on the frame via a Tetron mesh, and then a known photosensitive emulsion containing Si (an emulsion containing 80.68 at % carbon, 17.93 at % oxygen, and 1.4 at % silicon on the hydrogen-free basis in which hydrogen is not measured) was applied with a bucket onto the screen mesh to a thickness of 2 μm (corresponding to T2 in FIG. 2). That is, the emulsion was applied such that the total target thickness of the screen mesh and the photosensitive emulsion applied is 19 to 20 μm (accordingly, the target thickness for the thickness T2 of the emulsion is 1 to 2 μm).

The total thicknesses (corresponding to T1+T2) of the two screen printing plates thus obtained were measured at five points, that is, the four corners and the middle. The measurement apparatus used was PROTEC MODEL MG-500CTN. The measurement result was as follows.

The first screen printing plate
19.8 μm (middle)
19.8 μm (upper left corner)
19.7 μm (upper right corner)
19.9 μm (lower left corner)
19.3 μm (lower right corner)
   The second screen printing plate
19.9 μm (middle)
19.9 μm (upper left corner)
20.2 μm (upper right corner)
20.3 μm (lower left corner)
19.5 μm (lower right corner)

This measurement result indicates that all the thicknesses of the first screen printing plate were within the region of the target thickness, while the thicknesses at the upper right corner and the lower left corner of the second screen printing plate were outside the region of the target thickness. Thus, it is difficult to uniform the thickness of an emulsion applied by the direct method in a submicron order.

Next, the second screen printing plate was placed on an electrically conductive specimen support provided in a reaction container of a DC plasma CVD apparatus, and the mesh of this screen printing plate was connected to a negative electrode of the DC plasma CVD apparatus. The specimen was placed on the specimen support with the squeegeed surface thereof facing the specimen support and the printing surface thereof facing upward. Then, the reaction container was exhausted to a vacuum level of 3×10⁻³ Pa. Next, a mixture of oxygen gas of a flow rate 80 SCCM and Ar gas of a flow rate 40 SCCM was introduced into the reaction container at a gas pressure of 2 Pa, a plasma was generated under the condition of an applied voltage of −3 kVp, a pulse frequency of 10 kHz, and a pulse width of 2 μs, and the screen printing plate on the specimen support was subjected to dry etching for ten minutes. Subsequently, the screen printing plate was left standing for 15 minutes in the reaction container for cooling, and then subjected to dry etching again under the same condition. The dry etching was performed six times in total (accordingly, the dry etching was performed for 60 minutes (six times 10 minutes)).

Next, the reaction container was returned to a normal pressure, the screen printing plate was taken out, and the total thicknesses (corresponding to T1+T2) at five points of the screen printing plate were measured again. The thicknesses were measured at the same points as before the etching. The measurement result was as follows.
19.5 μm (middle) (reduced by 0.4 μm)
19.5 μm (upper left corner) (reduced by 0.4 μm)
19.7 μm (upper right corner) (reduced by 0.5 μm)
19.8 μm (lower left corner) (reduced by 0.5 μm)
19.1 μm (lower right corner) (reduced by 0.4 μm)

Thus, it was found that the emulsion containing carbon may be subjected to dry etching with a plasma containing oxygen so as to reduce the thickness of the emulsion formed on the mesh, and that the thickness of the emulsion can be uniformed because thick portions of the emulsion may be etched by a larger amount. The thickness of the emulsion can be adjusted by the time of the dry etching. Accordingly, the carbon-containing emulsion may be applied to the mesh by the direct method to a thickness slightly larger than the target thickness before plasma dry etching, so as to control the thickness of the emulsion in a submicron order and form the emulsion to a thickness conforming to the target thickness. As described above, the thickness of the emulsion can be adjusted by adjusting the total time of etching.

Thus, in an embodiment of the present invention, the thickness of the emulsion applied to the mesh may be reduced by dry etching and uniformed in the macro region.

Next, it was confirmed that, in the following method, a photosensitive emulsion other than that used in the above embodiment can be used to uniform the thickness of the surface of the emulsion in the macro region by dry etching and to form an unevenness structure in the surface of the emulsion in the nano order.

First, a frame of a size 450 mm by 450 mm and a rectangular stainless steel (SUS304) screen mesh ST500-19 having a size 250 mm by 250 mm and including a Tetron (polyester) mesh combined therewith at the middle were prepared. A photosensitive emulsion not containing Si (Expert 7 from MINOSHOJI CO., LTD.) was applied to the mesh such that the total thickness of the mesh and the emulsion was 60 nm. Thus, three emulsion screen printing plates having the emulsion applied onto the mesh were prepared.

Next, each of the three emulsion screen printing plates was masked with a resin film at a half of the region of 60 mm square around the middle thereof. The masked emulsion printing plates were placed on an electrically conductive specimen support provided in a reaction container of a DC plasma CVD apparatus, and the mesh of this screen printing plate was connected to a negative electrode of the DC plasma CVD apparatus. The specimen was placed on the specimen support with the squeegeed surface thereof facing the specimen support and the printing surface thereof facing upward. Then, the reaction container was exhausted to a vacuum level of 3×10⁻³ Pa. Next, a mixture of oxygen gas of a flow rate 80 SCCM and Ar gas of a flow rate 40 SCCM was introduced into the reaction container at a gas pressure of 2 Pa, a plasma was generated under the condition of an applied voltage of −3 kVp, a pulse frequency of 10 kHz, and a pulse width of 2 μs, and the screen printing plate on the specimen support was subjected to dry etching for ten minutes. The first emulsion screen printing plate was then left standing for 15 minutes in the reaction container for cooling, and then subjected to dry etching again under the same condition for five minutes. Accordingly, the first screen printing plate was subjected to dry etching for 15 minutes in total. The second emulsion screen printing plate was subjected to ten minute dry etching for three times, that is, 30 minutes in total. The third emulsion screen printing plate was subjected to ten minute dry etching for six times, that is, 60 minutes in total.

Thus, three specimens of emulsion screen printing plates having the surface of the emulsion subjected to dry etching were prepared. The middle portion of the emulsion screen printing plate subjected to dry etching for 30 minutes was cut off. This middle portion of the emulsion screen printing plate included a portion not subjected to dry etching (the masked portion) and a portion subjected to dry etching. Laser microscope photographs of these portions were taken to compare the smoothness of these portions. The photographing was performed using a laser microscope VK-9510 from Keyence Corporation.

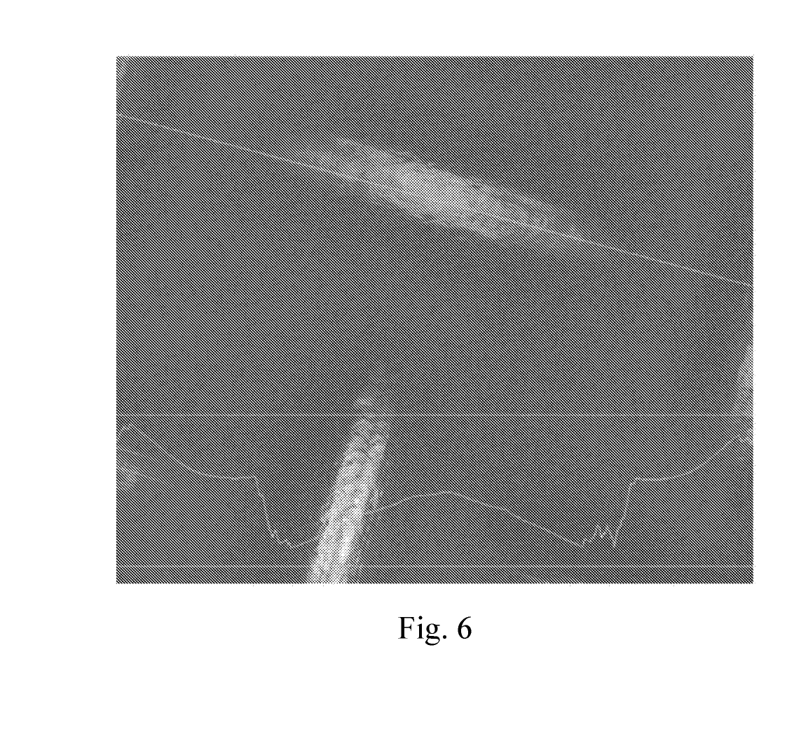

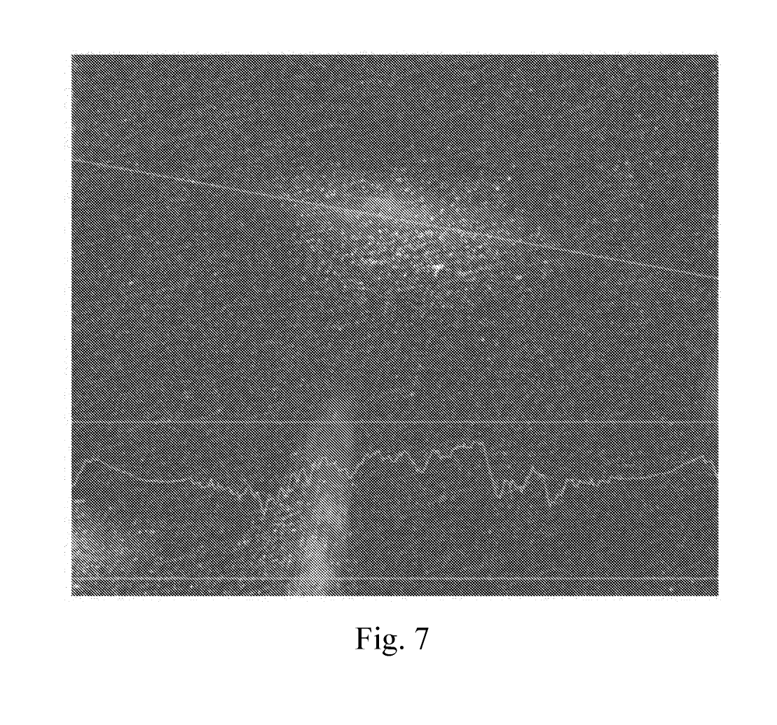

The laser microscope photographs thus taken are shown in FIGS. 6 and 7. FIG. 6 is a laser microscope photograph of the portion of the middle portion of the emulsion screen printing plate not subjected to dry etching (the masked portion), and FIG. 7 is a laser microscope photograph of the portion of the middle portion of the emulsion screen printing plate subjected to dry etching (the portion not masked). In FIGS. 6 and 7, the portions appearing white are intersections of mesh fiber threads, and the curved line in the lower portion of the figure represents the profile.

In FIG. 6, which shows the surface layer before dry etching, the intersections of the mesh fiber threads clearly appear while. In contrast, FIG. 7 shows the surface layer after dry etching, in which white patterns appearing around the intersections of the mesh fiber threads are obscure, indicating that the unevenness (irregularity) in the surface layer of the substrate was smoothened in the macro region.

The surface roughnesses (ten point average roughness (Rz)) of the middle portions of the three emulsion screen printing plates were measured at the portion not subjected to dry etching (the masked portion) and the portion subjected to dry etching (the portion not masked) in accordance with JIS B0601 (1994) using an atomic force microscope (AFM) measurement apparatus (Nano-12 AFM from Pacific Nanotechnology).

Next, the thicknesses of the portions subjected to dry etching (the portions not masked) of each of the three screen printing plates (subjected to dry etching for 15 min., 30 min., and 60 min.) were measured, thereby to determine the amount of reduction in the thickness of the emulsion during the dry etching. Additionally, each of the screen printing plates were measured for the arithmetic average roughness (Sa), the maximum height (Sy), and the ten point average roughness (Rz) of the surface layer of the emulsion. The measurement was performed as follows. A small piece was cut off from each of the three screen printing plates, and the emulsion side of these small pieces were filled with a resin and then polished. The sections of the polished small pieces were photographed to measure the thickness of the emulsion around the peaks of the mesh intersections on the side to which the emulsion is applied (the print substrate surface side). That is, the emulsion was cross-sectioned to measure the thickness (and the amount of reduction of the thickness). The sections were photographed using an electron microscope (FE-SEM) measurement apparatus (FE-SEM SU-70 from Hitachi High-Technologies Corporation). Likewise, the portions of the screen printing plates not subjected to dry etching (the masked portions) were measured for Sa, Sy, and Rz.

The measurement result is shown below. First, the portions of the screen printing plates not subjected to dry etching (the masked portions) were determined to have Sa of 15.5 nm, Sy of 177 nm, and Rz of 164 nm. The measurement result of the portions of the screen printing plates subjected to dry etching (the portions not masked) was as follows.

1) The screen printing plate subjected to dry etching for 15 min. was determined to have Sa of 16.1 nm, Sy of 288.2 nm, and Rz of 281.8 nm, and the thickness of the emulsion was reduced by 0.09 nm.
2) The screen printing plate subjected to dry etching for 30 min. was determined to have Sa of 38.3 nm, Sy of 439 nm, and Rz of 327 nm, and the thickness of the emulsion was reduced by 0.19 μm.
3) The screen printing plate subjected to dry etching for 60 min. was determined to have Sa of 59.5 nm, Sy of 661 nm, and Rz of 563 nm, and the thickness of the emulsion was reduced by 0.41 μm.

Thus, it can be understood that the thickness of the emulsion is reduced by about 0.1 μm for each 15 min. of dry etching. It was also confirmed that the surface roughness increases almost in accordance with the duration of dry etching.

The electron microscope photographs of the surfaces of the portions of the screen printing plates not subjected to dry etching (the masked portions) and the portions subjected to dry etching for 15 min., 30 min., and 60 min. were taken at ten thousand magnifications. These photographs show that the portions subjected to dry etching had numerous projections that were thinner toward the tip ends thereof. In contrast, it was confirmed that the portions not subjected to dry etching (the masked portions) had no such projections, but instead, there were holes formed by air in the plain surface. This is because the emulsion was exposed to light while being pressed against a glass film plate and thus the surface layer and the smooth surface of the glass film plate were transferred.

Next, the wettability (contact angle) with water (pure water) was measured at the surfaces of the portions of the screen printing plates prepared as described above not subjected to dry etching (the masked portions) and the portions subjected to dry etching for 60 min. Measurement environment had a temperature of 25° C.±5° C. and a humidity of 30%. Measurement apparatus and the measurement conditions were as follows.
Measurement apparatus: portable contact angle gauge PCA-1 from Kyowa Interface Science Co., Ltd
Measurement range: 0 to 180° (display resolution 0.1°)
Measurement method: contact angle measurement (drop method)
Measurement liquid: pure water
Amount of measurement liquid: 0.5 μl

The contact angle was measured at any five points for each of the portions not subjected to dry etching and the portions subjected to dry etching for 60 min., and the average values thereof were calculated. The average value of the contact angle of the portions not subjected to dry etching was 96.6°, exhibiting water repellence. In contrast, the average value of the contact angle of the portions subjected to dry etching for 60 min. was 13.6°, indicating that hydrophilic surfaces having a significantly high wettability with water were obtained. This indicates that a large number of functional groups having such a polarity as to absorb bipolar water molecules well were formed on the surface layer of the etched emulsion, and thus the surface was energized.

Next, it was confirmed that the following method can be used to etch the emulsion with a plasma including at least one element selected from the group consisting of O, N, H, F, and Ar, thereby to form a large number of projections in the surface of the emulsion.

First, a stainless steel mesh ST500-19 was mounted on a frame, and then a photosensitive emulsion containing Si (an emulsion containing 80.68 at % carbon, 17.93 at % oxygen, and 1.4 at % silicon on the hydrogen-free basis in which hydrogen is not measured) was applied onto the screen mesh to a thickness of 20 μm (corresponding to T2 in FIG. 2). From the mesh having the emulsion applied thereto, three rectangular pieces each having a size of 100 mm by 100 mm were cut out. Further, the same mesh was mounted on the same frame, and then an emulsion (Expert 7 from MINOSHOJI CO., LTD.) not containing Si was applied onto the mesh. From the mesh having the emulsion applied thereto, one rectangular piece having a size of 100 mm by 100 mm was cut out.

Each of the four specimens thus obtained (the meshes having the emulsion applied thereto) was placed on an electrically conductive specimen support provided in a reaction container of a DC plasma CVD apparatus, and the mesh of the screen printing plate was connected to a negative electrode of the DC plasma CVD apparatus. The specimen was placed on the specimen support with the squeegeed surface thereof facing the specimen support and the surface thereof corresponding to the printing surface facing upward. Then, the reaction container was exhausted to a vacuum level of 3×10⁻³ Pa. Next, a mixture of oxygen gas of a flow rate 70 SCCM and Ar gas of a flow rate 40 SCCM was introduced into the reaction container at a gas pressure of 2 Pa, a plasma was generated under the condition of an applied voltage of −3 kVp, a pulse frequency of 10 kHz, and a pulse width of 2 μs, and the specimen (the emulsion) on the specimen support was subjected to dry etching for ten minutes. Subsequently, the screen printing plate was left standing for 20 minutes in the reaction container for cooling, and then subjected to dry etching again under the same condition. The dry etching was performed six times in total. Accordingly, the total time of the dry etching was 60 minutes. Thus, dry etching was performed for 60 min. in total to obtain the specimen of Example 1. Further, one of the four meshes having the emulsion applied thereto was subjected to dry etching for 120 min. in total to obtain the specimen of Example 2. Likewise, the dry etching was performed on the photosensitive emulsion not containing Si for 60 min. in total to obtain the specimen of Example 3. Further, one of the four meshes having the emulsion applied thereto was not subjected to dry etching and was taken as the specimen of Comparative Example 1.

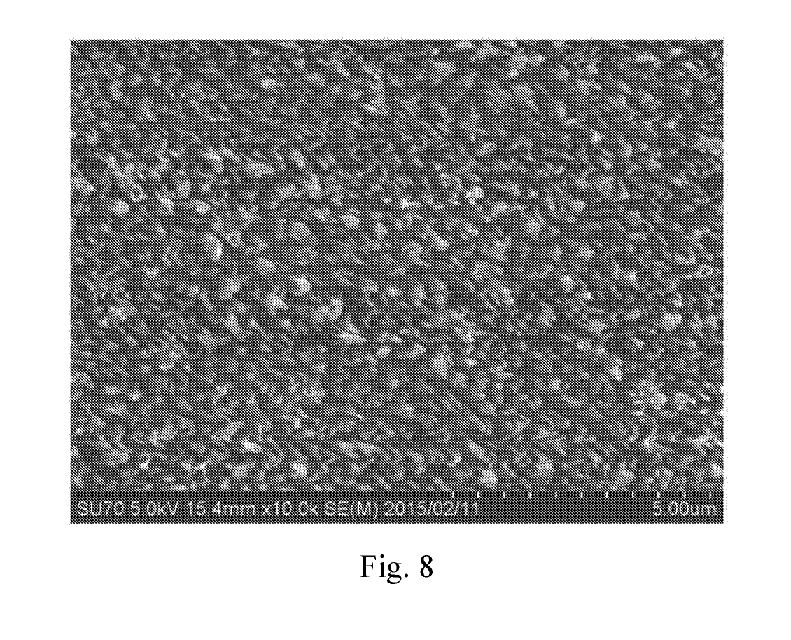

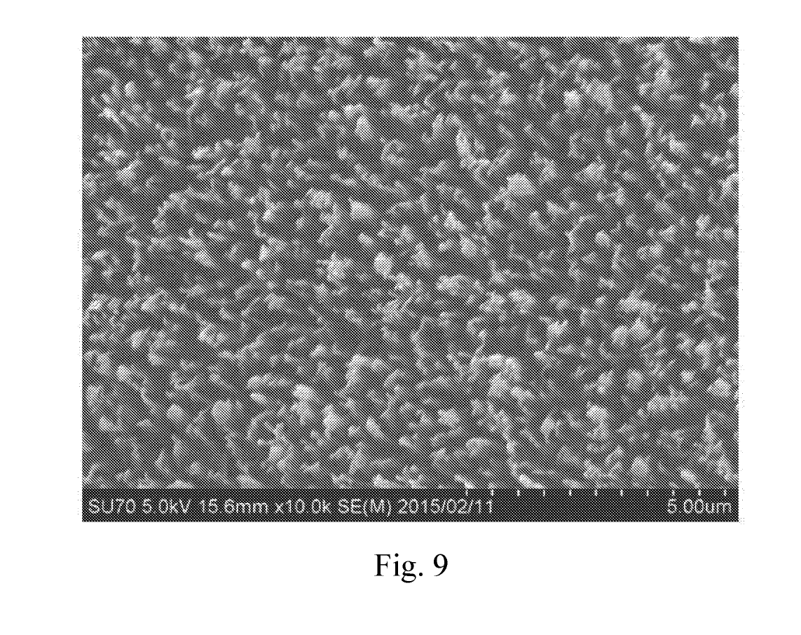

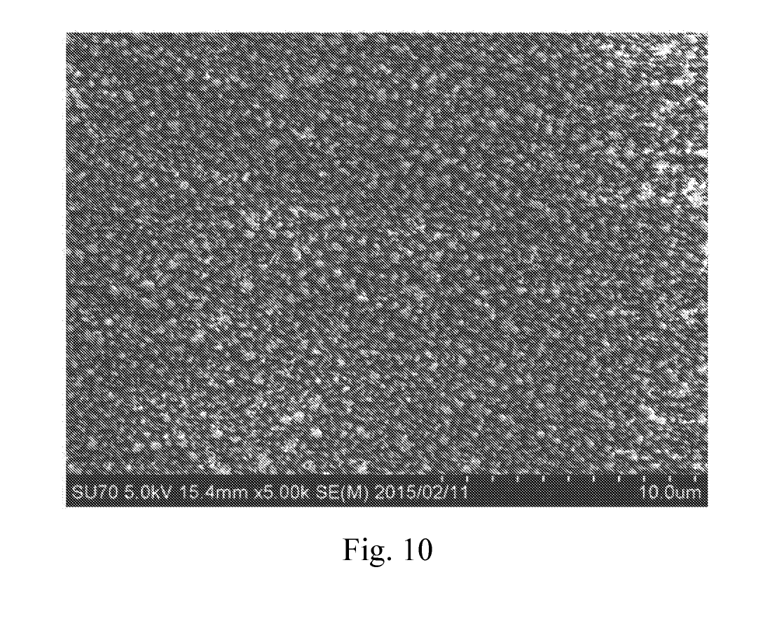

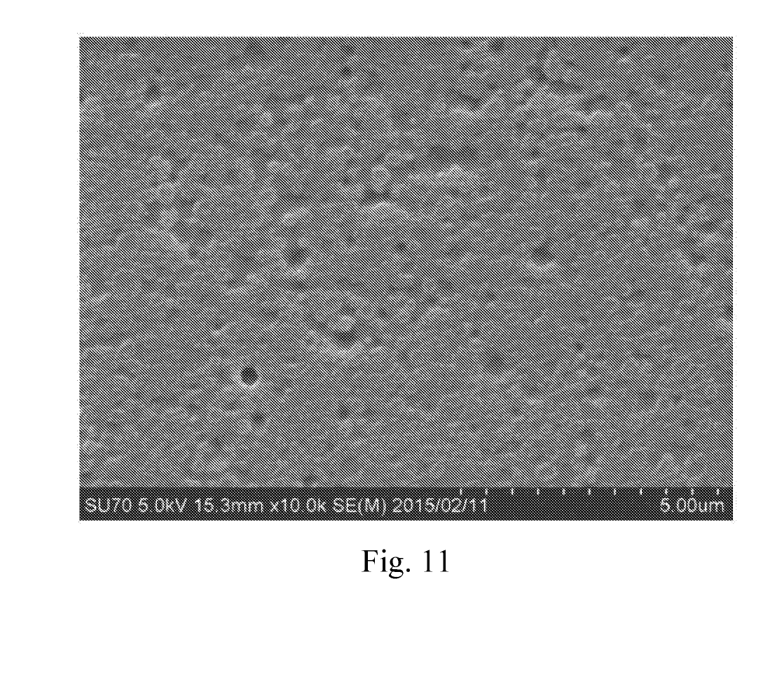

The surfaces of the Example 1, Example 2, and Comparative Example 1 were observed using an electron microscope (“FE-SEM SU-70” from Hitachi High-Technologies Corporation). The atomic force microscope (AFM) measurement apparatus (Nano-12 AFM from Pacific Nanotechnology) was used to take the electron microscope photograph of the surface of the specimen of Example 1 shown in FIG. 8, the electron microscope photograph of the surface of the specimen of Example 2 shown in FIG. 9, the electron microscope photograph of the surface of the specimen of Example 3 shown in FIG. 10, and the electron microscope photograph of the surface of the specimen of Comparative Example 1 shown in FIG. 11. Comparison of the photographs shown in FIGS. 8 to 10 with the photograph shown in FIG. 11 revealed that a large number of projections were formed in the surface of the specimens of Examples 1 and 2 by plasma etching. The surface roughnesses measured were 18.2 nm for Comparative Example 1, 59.4 nm for Example 1, and 83.0 nm for Example 2. The projections were formed because the portions of the emulsion in the specimen not containing Si were etched deeply while the portions of the emulsion containing Si and the portions therebelow were not etched.

Thus, it was found that the emulsion containing Si may be subjected to plasma etching to reduce the average thickness of the emulsion as compared to that before etching and form an unevenness structure in the surface of the emulsion in the nano order. The same result can also be obtained using Ti, Al, and Zr, and a compound thereof, in place of or in addition to Si, as an additive added to the emulsion.

In the above Examples, Ar (argon) gas and O (oxygen) gas were used as etching gas to form the unevenness structure in the surface of the emulsion in the nano order. Additionally, N (nitrogen) and/or H (hydrogen) can also be used as etching gas to form the same fine unevenness structure. This is because plasma application of nitrogen onto a substrate composed of an organic material causes nitrogen to react with carbon in the substrate to from CN, and plasma application of hydrogen onto the substrate causes hydrogen to react with carbon to form CHₓ.

Composition analysis of the specimen of Example 1 was performed using FE-SEM measurement apparatus (FE-SEM SU-70 from Hitachi High Technologies Corporation). As a result, Example 1 was composed of 62.3 at % carbon, 35.09 at % oxygen, and 2.62 at % silicon on the hydrogen-free basis in which hydrogen is not measured. Thus, it was confirmed that the composition ratio of carbon was reduced while those of oxygen and silicon were increased. Oxygen was taken in from the material gas of plasma, and silicon is less prone to be removed by dry etching, which increased the composition ratios thereof. Since the emulsion of a printing stencil needs exposure and development for forming a pattern, it is difficult to previously introduce certain components into the emulsion in a single element form or as a compound, or in the form of fine powder, filler, or lot at a high concentration in a layer form. Such components include glass, metals, metal oxides (ceramic), and diamond which inhibit exposure, wear resistant components such as CNT and electrically conductive components, lubricant components, coloring matters, elements such as Si, Ti, Al, Zr, and P which produce hydroxyl groups or carbonyl groups prone to condensation reaction with coupling agents, and other desired components. These components may be previously dispersed widely in the emulsion at a low concentration, and subjected to dry etching after exposure and development (taking advantage of the difference in etching rate from the emulsion) so as to readily concentrate the above useful substances in the surface layer of the emulsion.

Next, analysis was performed on the surface roughness and wettability of a specimen in which a fine unevenness structure was formed by dry etching according to the present invention in an organic polymer material such as a conventional resin.

First, a commercially available transparent acrylic resin plate (an Acrysunday plate from Acrysunday Co., Ltd. (color number: 001, transparent)) was prepared, and this acrylic resin plate was cut into a size of 40 mm by 40 mm with a thickness of 2 mm. The cut acrylic resin plate was placed on an electrically conductive specimen support provided in a reaction container of a DC plasma CVD apparatus, and then the reaction container was exhausted to a vacuum level of 3×10⁻³ Pa. Next, a mixture of oxygen gas of a flow rate 70 SCCM and Ar gas of a flow rate 30 SCCM was introduced into the reaction container at a gas pressure of 2 Pa, a plasma was generated under the condition of an applied voltage of −3 kVp, a pulse frequency of 10 kHz, and a pulse width of 1 μs, and the acrylic resin plate on the specimen support was subjected to dry etching. The dry etching was performed while confirming that the temperature indicator of a thermolabel affixed near the acrylic resin plate (a thermolabel indicating that the temperature has reached 60° C.) does not change the color thereof, such that the acrylic resin plate does not exceed the heat deformation temperature. More specifically, by a repeated cycle of three minutes of dry etching on the acrylic resin plate and 15 minutes of suspension of dry etching for cooling the specimen, the acrylic resin plate was prevented from exceeding the heat deformation temperature thereof. Thus, one of the acrylic resin plates was subjected to dry etching for ten minutes in total (in the last cycle, the dry etching was performed for one minute and stopped), and another of the acrylic resin plates was subjected to dry etching for 30 minutes in total.

Both the acrylic resin plate subjected to dry etching for ten minutes and the acrylic resin plate subjected to dry etching for 30 minutes maintained sufficient transparency when the etching was completed. However, the acrylic resin plate subjected to dry etching for 30 minutes had a slightly matte appearance.

Subsequently, an amorphous carbon film was formed on each of the acrylic resin plate subjected to dry etching for ten minutes and the acrylic resin plate subjected to dry etching for 30 minutes, and oxygen was introduced into the amorphous carbon film, as follows. First, the dry etching was performed as described above, and then the reaction container was exhausted of Ar and oxygen to a vacuum level of 3×10⁻³ Pa. Next, trimethylsilane gas of a flow rate 30 SCCM was introduced into the reaction container at a gas pressure of 0.26 Pa, a plasma was generated under the condition of an applied voltage of −4 kVp, a pulse frequency of 10 kHz, and a pulse width of 10 μs, and a Si-containing amorphous carbon film was formed for 30 minutes on the acrylic resin plate on the specimen support. Next, the trimethylsilane gas was discharged, and then oxygen gas of a flow rate 30 SCCM was introduced into the reaction container at a gas pressure of 0.3 Pa, a plasma was generated under the condition of an applied voltage of −3 kVp, a pulse frequency of 10 kHz, and a pulse width of 10 μs, and oxygen was introduced (injected) into a Si-containing amorphous carbon film formed on the acrylic resin plate. After introduction of the oxygen, the acrylic resin plate was left standing for 15 minutes for cooling, and then the trimethylsilane gas was introduced by the same procedure and under the same condition as above to further form the Si-containing amorphous carbon film, and oxygen was introduced again into the Si-containing amorphous carbon film by the same procedure and under the same condition as above.

As described above, a Si-containing amorphous carbon film was formed on the acrylic resin plate subjected to dry etching for ten minutes, and oxygen was introduced into the Si-containing amorphous carbon film. This specimen was taken as Example A. A Si-containing amorphous carbon film was formed on the acrylic resin plate subjected to dry etching for 30 minutes, and oxygen was introduced into the Si-containing amorphous carbon film. This specimen was taken as Example B. The commercially available acrylic resin plate prepared and subjected to no treatment was taken as Comparative Example C. Further, on the commercially available acrylic resin plate prepared and not subjected to the dry etching with the mixture of Ar and oxygen, a Si-containing amorphous carbon film was formed by the same procedure and under the same condition as above, and oxygen was introduced into the amorphous carbon film using oxygen gas plasma by the same procedure and under the same condition as above. This specimen was taken as Comparative Example D. It was confirmed that both the specimens of Example A and Example B maintained the transparency thereof. In particular, for the specimen of Example B having a rough surface, the total light transmissivity measured by U-4100 spectrophotometer from Hitachi High-Technologies Corporation was 86%, the haze measured by the haze meter HZ-2 (conforming to JIS K7136 and JIS K7361-1) from Suga Test Instruments Co., Ltd. with D65 light was 0.9, and b* measured by the spectral colorimeter CM-508d from Minolta Camera Co., Ltd. with a pulsed xenon lamp as a measurement light source was 1.0.

Subsequently, the surface roughnesses (ten point average roughness (Rz)) of the three specimens of Example A, Example B, and Comparative Example C were measured in accordance with JIS B0601 (1994) using an atomic force microscope (AFM) measurement apparatus (Nano-12 AFM from Pacific Nanotechnology). The measurement result is shown below.

### 1) Comparative Example C

### Untreated Acrylic Resin Plate

Sa of 1.1 nm, Sy of 19.1 nm, and Rz of 16.4 nm

### 2) Example A

### Subjected to Dry Etching for Ten Minutes

Sa of 0.4 nm, Sy of 8.5 nm, and Rz of 6.6 nm

### 3) Example B

### Subjected to Dry Etching for 30 Minutes

Sa of 2.4 nm, Sy of 85.1 nm, and Rz of 81.0 nm

Comparison between the surface roughness of Comparative Example C and the surface roughness of Example A revealed that the surface layer of the acrylic resin plate was made extremely smooth by dry etching as compared to the untreated surface layer. Therefore, an acrylic resin having a surface smoothened by dry etching is suitable not only as a substrate of a printing stencil but as a material for various applications demanding improved slidability and reduced sliding resistance. Such smoothness of a surface layer can be suitably used for slidability of droplets or snow on a surface layer of a substrate made of PET, acrylic, polycarbonate, urethane, or other transparent organic polymer resins. Specific examples to which the smoothness provided by dry etching can be applied include lenses and lens covers of various cameras such as onboard cameras mounted on automobiles, airplanes, ships, and railroad vehicles, lenses and lens covers of various all-weather surveillance cameras, lenses and lens covers of microscopes, telescopes, periscopes, glasses, and endoscopes, exterior covers of automobile lights, photovoltaic power generation panels, concentrating solar power generation panels, traffic signs, and lenses and lens covers of signals. Application of smoothness on these surface layers in accordance with the present invention causes raindrops and snow to slide down from the surface layers, preventing adhesion of raindrops and snow. Other specific examples to which the smoothness provided by dry etching can be applied include a printing substrate surface of a printing stencil and an ink projecting side surface of an inkjet nozzle for printing. These surfaces may be provided with smoothness to improve slidability of an ink. After smoothening a surface of a resin substrate as described above, a water-repellent film may be provided on the surface layer, or a hard film made of an amorphous carbon film, silicon oxide, titanium oxide, zinc oxide, etc. may be formed on the surface of the resin substrate, so as to improve the wear resistance of the surface of the substrate, causing the smoothness of the surface layer to retain for a long period.

Comparison between the surface roughnesses of Comparative Example C, Example A, and Example B confirmed that longer duration of dry etching on the samples of acrylic resin plates roughened the surfaces of the samples as compared to the untreated sample. More specifically, measurement of surface roughness revealed that the difference in height between high portions and low portions of the unevenness in the surface layer of the acrylic resin plate subjected to dry etching for ten minutes (Example A) was about the half of the difference in height between high portions and low portions of the unevenness in the surface layer of the untreated substrate (Comparative Example C) (that is, smoothened), and the difference in height between high portions and low portions of the unevenness in the surface layer of the acrylic resin plate subjected to dry etching for 30 minutes (Example B) was about four times that of Comparative Example C, indicating that the surface layer of the acrylic resin plate subjected to dry etching for 30 minutes has a fractal structure having a large surface area.

Thus, various resins composed of carbon and hydrogen and organic polymer materials such as rubber may be subjected to dry etching using oxygen such that oxygen reacts with carbon and hydrogen, resulting in chemical change of the surface shape or roughness.

As described above, the transparency was retained after dry etching on a transparent acrylic resin plate. Accordingly, it was confirmed that smoothening of a substrate by dry etching can restrict deterioration of transparency and increase of scatter of light on the surface of the substrate, as opposed to smoothening of a substrate by physical grinding such as sandblasting or grinding. Likewise, it was confirmed that roughening of a substrate by dry etching can restrict deterioration of transparency and increase of scatter of light on the surface of the substrate, as opposed to roughening of a substrate by physical grinding such as sandblasting or grinding.

Smoothening and roughening by dry etching advantageously do not need an expensive apparatus or die as compared to forming of a fine unevenness structure in an organic polymer material using a nanoimprint die, for example, forming (transferring) of a “moth eye” structure having fine unevenness as in the surface layer of an eye of a moth by pressing a nanoimprint die against a resin.

As described above, in smoothening a surface layer of an organic polymer material or forming a fine unevenness structure in a surface layer of an organic polymer material by dry etching, the duration of the dry etching or plasma conditions of the dry etching can be adjusted to vary the roughness of the surface to be formed and the amount of etching of the substrate with ease. Accordingly, smoothening a surface layer of a substrate and forming a fine unevenness structure in a surface layer of a substrate by dry etching is cost-effective, easy to control, and reproducible as compared to physical etching requiring grinding materials and dies to be prepared in accordance with necessary roughness and amount of grinding.

Further, as opposed to forming unevenness in a film formed on a substrate and composed of other components, forming an unevenness structure in a surface layer of a substrate itself by dry etching can largely restrict removal of the other components from the substrate and impact of contaminants, and can retain the external characteristics of the substrate such as affinity with organisms in medical articles.

Next, wettability (contact angle) with water (pure water) was measured at the surfaces of the samples of Example A, Example B, Comparative Example C, and Comparative Example D. Measurement environment had a temperature of 25° C.±5° C. and a humidity of 30%. Measurement apparatus and the measurement conditions were as follows.
Measurement apparatus: portable contact angle gauge PCA-1 from Kyowa Interface Science Co., Ltd
Measurement range: 0 to 180° (display resolution 0.1°)
Measurement method: contact angle measurement (drop method)
Measurement liquid: pure water
Amount of measurement liquid: 1 μl

The first measurement was performed after the samples taken out of the plasma reaction container were kept from foreign substances that may contact the surfaces thereof and were left standing for 72 hours. Each of the samples was measured for contact angles at any five points thereof, and the average value of the contact angles was calculated. The measurement result was as follows.
Comparative Example C: 64.3°
Comparative Example D: 3.9°
Example A: 3.8°
Example B: 3.2°

Thus, any of the examples having a transparent amorphous carbon film containing Si and oxygen (that is, the examples other than Comparative Example C) exhibited a high hydrophilicity.

Next, an acrylic resin plate was subjected to dry etching and an amorphous carbon film was formed on the acrylic resin plate by the same procedure and under the same condition as for Example A, a transparent amorphous carbon film containing Si and oxygen was formed on the surface of the acrylic resin plate, and the amorphous carbon film was coated at the surface thereof with a fluorine-containing coupling agent (Fluorosurf FG-5010Z130-0.2 (containing 0.02 to 0.2% fluorine resin and 99.8 to 99.98% fluorine-based solvent) from Fluoro Technology Corporation). The acrylic resin plate was then left standing for 24 hours. This sample was taken as Reference Example A. Next, an acrylic resin plate was subjected to dry etching and an amorphous carbon film was formed on the acrylic resin plate by the same procedure and under the same condition as for Example B, and the acrylic resin plate was coated at the surface thereof with a fluorine-containing coupling agent (Fluorosurf FG-5010Z130-0.2 from Fluoro Technology Corporation) and then left standing for 24 hours. This sample was taken as Reference Example B. The contact angle with water was measured for Reference Example A and Reference Example B by the same measurement method as described above. The measurement result was as follows.
Reference Example A: 100.5°
Reference Example B: 100.8°

Thus, both Reference Example A and Reference Example B exhibited water repellence, but the water repellence of Reference Example B having a fine unevenness structure in the surface layer thereof was far below the contact angle with water of 140° which indicates “super water repellence.” This is because the fine unevenness formed in Reference Example B is nanoscale, and Reference Example B does not have a rougher micronscale unevenness structure for producing super water repellence. To produce super water repellence, it is necessary to previously form a micronscale unevenness structure in a substrate by a nanoimprint die. Thus, a substrate having a micronscale unevenness structure formed therein may be subjected to dry etching in the same manner as described above, so as to form fine nanoscale unevenness in the surface layer of the rougher micronscale unevenness structure in the surface layer of the substrate, thereby achieving “fractal structure.”

If an organic polymer film is used as the substrate, a nanoimprint die may be used for example, to form a micronscale unevenness structure in the surface layer of the substrate, or if a glass substrate is used as the substrate, chemical etching with fluorinated acid, etc. or scratching with laser beams may be performed to form a micronscale unevenness structure in the surface layer of the substrate.

A transparent amorphous carbon film containing Si and oxygen was formed on a slide glass (MICRO SLIDE GLASS (model number: 51111, size: 76×26 mm, thickness: 0.8 to 1.0 mm, pre-cleaned: white-rimmed polishing No. 1) from Matsunami Glass Ind, Ltd) by the same procedure and under the same condition as described above. The optical characteristics of the slide glass having the amorphous carbon film formed thereon included a total light transmissivity of about 90%, a haze of 0.7, and b* of 0.6 (the apparatuses used for the measurement were the same as described above). Thus, the slide glass having the amorphous carbon film containing Si and oxygen formed thereon had transparent optical characteristics.

Subsequently, over a long time period after the plasma process, the hydrophilic•functional groups formed by plasma in the surface layer of the samples are deteriorated by adsorption of substances in the ambient air or deactivation. In addition to chemical hydrophilicity, the structural hydrophilicity (originated mainly from physical unevenness structure) having a long term stability was observed by measuring the contact angles for Comparative Example C, Comparative Example D, and Example B at 264 hours after the plasma process by the same measurement method as described above. The measurement result was as follows.
Comparative Example C: 65.3°
Comparative Example D: 35.4°
Example B: 16.6°

The above measurement result confirmed that the hydrophilicity of Example B is retained for a relatively long period. This is because the structural hydrophilicity originated from the unevenness structure formed in the surface layer of Example B is retained for a relatively long period.

The contact angle with water of Example B is less than 20° (at a level regarded as a water film). Accordingly, the structure like Example B needs antifog ability and self-cleaning ability using rainwater, and is suitable for applications requiring hydrophilicity to be retained for a long period. For example, the structure of Example B can be used as a defogger in the surface layer of glass or a transparent organic polymer resin substrate such as PET, acrylic, polycarbonate, or urethane requiring high transparency, and can be used for providing self-cleaning ability using water to the surface layer of glass or an organic polymer resin substrate. Specific examples of applications requiring antifog and self-cleaning abilities include lenses and lens covers of various cameras such as onboard cameras mounted on automobiles, airplanes, ships, and railroad vehicles, lenses and lens covers of various all-weather surveillance cameras (including covers of the entire camera bodies), lenses and lens covers of microscopes, telescopes, periscopes, glasses, and endoscopes, defoggers in reflectors of automobile lights, photovoltaic power generation panels, concentrating solar power generation panels, traffic signs, and lenses of signals. Further, the structure of Example B can also be applied to applications requiring wettability and loading performance for ink. Specific examples of applications requiring wettability and loading performance of ink include an ink-feeding surface of a printing ink-jet nozzle, a sectional portion of a feed orifice in a printing ink-jet nozzle, and a squeegeed surface of a printing stencil. Further, the structure of Example B can be suitably applied to applications requiring wettability with blood or body fluids to be retained for a long period, such as medical catheters composed of an organic polymer substrate. In this application, the substrate may also be sterilized with ultraviolet rays or active oxygen generated during plasma dry etching for forming unevenness in the substrate.

A hydrophilic organic polymer film having fine unevenness structure in the surface layer thereof according to the embodiment of the present invention can be affixed on a body composed of various materials requiring hydrophilicity. Examples of such a body include a protection film on the surface of an electron display device (for reducing fingerprint visibility) and window glasses of vehicles and buildings.

After the surface of a resin substrate is tentatively roughened, a hydrophilic film (e.g., an amorphous carbon film containing Si and oxygen described above, a silicon oxide film, a titanium oxide film (including a photocatalyst film made of titanium dioxide, etc.), a sputter film or evaporated film such as a zinc oxide film) may be chemically formed on the roughened surface, or a hard film such as an amorphous carbon film may be formed on the roughened surface, so as to retain the roughened structure in the surface layer of the substrate for a long period.

A printing stencil to be used may include a printing frame, and a transparent organic polymer film affixed on the printing frame and having a printing pattern opening formed therein by laser such as excimer laser. With such a printing stencil, the pattern on a printing medium is visible from the squeegeed surface side of the printing stencil through the organic polymer film, facilitating alignment of the pattern in the printing stencil with the pattern on the printing medium.

What is claimed is:

1. A method for manufacturing a printing stencil, the method comprising:
preparing a substrate having a printing pattern opening formed therein and having a printing surface including an organic material; and
performing dry etching on the printing surface.

2. The method of claim 1 wherein the substrate includes a frame, a mesh mounted on the frame, and a carbon-containing emulsion provided on the mesh.

3. The method of claim 2 wherein the emulsion comprises a photosensitive emulsion, and wherein the method further comprises exposing the emulsion to light after the dry etching.

4. The method of claim 2 wherein the emulsion comprises a photosensitive emulsion, and wherein the method further comprises exposing the emulsion to light before the dry etching.

5. The method of claim 1 further comprising forming a coating film on the printing surface after the dry etching.

6. The method of claim 1 wherein the dry etching is performed using a material gas including at least one element selected from the group consisting of O, N, H, F, and Ar.

7. The method of claim 1 wherein an average roughness (Rz) of the printing surface is smaller than an average particle size of metal powder included in a printing paste.

8. The method of claim 1 wherein the substrate includes an additive, and the dry etching is performed so as to form one or more projections including the additive in the printing surface.

9. The method of claim 8 wherein the additive comprises at least one substance selected from the group consisting of metal elements, metal oxides, and glass.

10. A printing stencil comprising a substrate having a printing pattern opening formed therein and having a printing surface including an organic material,
wherein the printing surface has one or more projections formed therein by dry etching.

11. The printing stencil of claim 10 wherein the substrate includes:
a frame;
a mesh mounted on the frame; and
a carbon-containing emulsion provided on the mesh.

12. The printing stencil of claim 10 further comprising a coating film formed on the printing surface.

13. The printing stencil of claim 10 wherein the one or more projections are formed by performing the dry etching on the printing surface using a material gas including at least one element selected from the group consisting of O, N, H, F, and Ar.

14. The printing stencil of claim 10 wherein an average roughness (Rz) of the printing surface is smaller than an average particle size of metal powder included in a printing paste.

15. The printing stencil of claim 10 wherein the emulsion contains an additive including at least one substance selected from the group consisting of metal elements, metal oxides, and glass.
